(19) United States
(12) Patent Application Publication
(10) Pub. No.: US 2013/0275503 A1
(43) Pub. Date: Oct. 17, 2013

(54) SYSTEM FOR INVIGORATING ONLINE SPORTS MATCH

(71) Applicant: Yung-Suk Sul, Seoul (KR)

(72) Inventor: Yung-Suk Sul, Seoul (KR)

(21) Appl. No.: 13/996,262

(22) PCT Filed: Dec. 29, 2010
(86) PCT No.: PCT/KR2010/009501

§ 371 Date: Jun. 20, 2013

(30) Foreign Application Priority Data
Dec. 23, 2010 (KR) 10-2010-0133837

(51) Int. Cl. H04L 29/08

(52) U.S. Cl. CPC H04L 67/22
USPC 709/203

(57) ABSTRACT

The present invention relates, in general, to a system for activating an online sports match and, more particularly, to a system for invigorating an online sports match, which provides technology for operating online sports matches so that amateur athletes form teams in their areas and enjoy playing sports with interest, and which improve convenience in organizing a sports meet while securing a larger number of available members, thus creating an environment in which sports matches can be invigorated. The system includes a member subscription module, a member management platform, a record management module, a team member management interface, and an organization management interface.

### BACKGROUND OF THE INVENTION

1. Field of the Invention

The present invention relates, in general, to a system for activating an online sports match and, more particularly, to a system for invigorating an online sports match, which provides technology for operating online sports matches so that amateur athletes form teams in their areas and enjoy playing sports with interest, and which improve convenience in organizing a sports meet while securing a larger number of available members, thus creating an environment in which sports matches can be invigorated.

2. Description of the Related Art

Amateur sports games may be regarded as more sound and preferable hobbies than other leisure activities including online games or computer games because sportsmen not only can improve their health but also can improve fellowship amongst themselves while sweating and making physical contact.

However, such an amateur sports game, since sportsmen play a game within the range of their narrow personal connections, their sports games are not well organized compared to sports meets held by professional athletes, so that it is currently difficult to hold periodic and systematic sports matches.

As a result of research into schemes for promoting amateur sports matches, it can be proven that the development of technologies related to the organization of teams based on the determination of levels of team members, the setting of sponsors, and the management of sports meets is important, but in reality, it is impossible to secure a sufficient number of persons and so there is no basis on which to smoothly organize sports meets.

That is, in order to invigorate sports meets, systematic sports meets can be continuously operated only when a larger number of amateur athletes pay attention to sports meets and actively conduct activities. According to well-known technology for securing persons who will participate in sports meets, only a scheme has been conducted which simply searches a relevant area for athletes based on Geographic Information System (GIS) or establishes matches only with other teams that they previously have had an acquaintance with. Therefore, there is a problem in that it is impossible to secure persons who do not know even whether a sports meet pursued by the present invention is present, and it is not easy to lead potential available athletic persons to sports meets because users have ever met the available athletic persons in the same stadium, but they did not play a match with the available athletic persons, or the available athletic persons are not members.

The inclinations of persons who subscribed as members, but who do not actively participate in activities create a problem which has been pointed out whereby persons are enticed to participate in sports meets based on only sports events, entered by the persons at the time when the persons initially subscribed as members, without accurately understanding their events of interest.

Furthermore, since the persons are not professional athletes, the time and place required for sports are inevitably limited, but a basis for organizing a sports meet in light of this realistic problem has not been put forth at the present time.

Therefore, there is required a new and advanced technology which will induce existing members who did not actively participate in sports matches to actively participate in sports matches, and reasonably and scientifically present opportunities to allow willing persons who do not yet subscribe as members to subscribe as members, and also support an differentiated incentive payment scheme after a sufficient number of athletic persons have been secured by sufficiently taking into consideration sports conditions of existing members, thus invigorating sports meets.

### SUMMARY OF THE INVENTION

Accordingly, the present invention has been made keeping in mind the above problems occurring in the prior art, and an object of the present invention is to provide a system for invigorating a sports match, which previously checks sports conditions, that is, daily schedules of members who can play sports, and organizes a sports meet with reference to the daily schedules, thus pursuing an environment in which a larger number of members can actively participate in the sports meet.

Another object of the present invention is to provide a temporal environment in which a sports meet can be more reasonably promoted by detecting a state in which a member actually visited a stadium using the positioning function of a mobile communication terminal currently held by the member and by analyzing a difference between a theoretical schedule and a realistic state.

In order to accomplish the above objects, the present invention provides a system for invigorating an online sports match, including a member subscription module for receiving member information and processing subscription of members; a member management platform for providing information about a sports meet to the members based on a social web; a record management module for storing and classifying information about results of sports matches of a team to which the members belong as team members and each of the team members; a team member management interface including a condition registration module for receiving and storing matching conditions required to organize a sports match on a team basis or on a team member basis, and revealing the matching conditions via the member management platform, and a free schedule registration module for generating free schedule information by extracting sports schedules and sports play time and place thereof; recorded in a schedule management program of a mobile communication terminal held by each team member, and revealing the free schedule information via the member management platform; and an organization management interface including a matching condition search module for providing a function of searching for at least one team and at least one team member that will participate in a sports match based on the matching conditions and the free schedule, and searching for at least one team and at least one team member that will participate in a sports match in a state in which the stadium visit data is additionally included, and a match organization module for sending a participation request to the team and the team member found by the matching condition search module and forming organization of the sports match when the team and the team member accept the request.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the configuration of a system for invigorating an online sports match;

FIG. 2 is a diagram illustrating the configuration of entrance/exit detection sensors and an input device installed on a stadium;

FIG. 3 is a flowchart schematically showing the procedure of determining the sports inclinations of team members and forming the organization of a sports match;

FIG. 4 is a flowchart schematically showing the procedure of analyzing sports that members who are inactive are recently interested in and inducing the members to participate in a sports match; and

FIG. 5 is a flowchart schematically showing the procedure of managing a rival team.

### DESCRIPTION OF THE PREFERRED EMBODIMENTS

Hereinafter, embodiments of the present invention will be described in detail with reference to the attached drawings. The drawings are not shown according to scale, and the same reference numerals are used throughout the different drawings to designate the same or similar components.

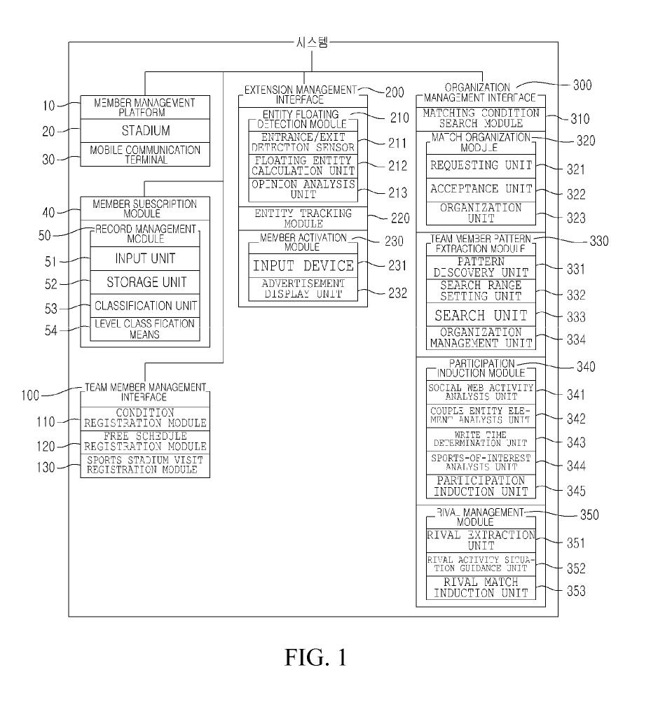

FIG. 1 is a block diagram schematically showing the configuration of a system for invigorating an online sports match.

The system of the present invention is characterized in that individual team members, as well as a manager, become principal members, so that a sports match can be more smoothly conducted while a larger number of team members enjoy the sports match. For this, the present invention provides a member management platform functioning to provide information about sports matches and online communication between members according to the present invention.

Such a member management platform 10 is a part of an open platform structure that provides Social Networking Service (SNS), and is configured to announce and share area-based and event-based information about various sports meets and sports matches, which are currently being held or are scheduled to be held and players are currently being assembled for. Further, the member management platform 10 can include the function of openly sharing data registered in individual modules of a team member management interface 100 and functions that are performed by well-known social network services (for example, Facebook or the like), such as chatting, writing comments, bookmarking, recommending, adding friends, finding friends, and viewing friends belonging to a service to which friends previously subscribed.

A member subscription module 40 according to the present invention functions to receive the basic information of members via a web page provided through a mobile interface provided by a mobile communication terminal 30 or provided in the environment of the Internet, or via the member management platform 10, and to arrange the basic information into a database (DB) for items or specific criteria, or in an integrated manner.

Members can be mainly classified into ‘sponsors’ and users, that is, ‘team members/teams’ and ‘supporters.’ The team members/teams denote users assembled to personally play a sports match, sponsors denote typical advertisers, and supporters denote an audience who view a sports match conducted by the team members/teams.

Information about team members/teams and member information may include the names of individual persons/teams, emails, mobile communication terminal numbers, ages, heights, gender, areas, preferred sports events, abilities, recent match records, etc., and information about sponsors may include the properties of advertisements, the types of products to be advertised, the range of support payments, etc.

The term “team member” denotes a title assigned when a certain member belongs to a specific team, and can be set such that individual members assemble and acquire the qualification of team members while voluntarily forming a team, or such that a team member belonging to a specific team is scouted or recommended for another team, or members having similar results are recommended by the system according to the present invention based on the results of team members generated by a record management module 50, which will be described later. The method of becoming a team member in the present invention is not especially limited to the above methods.

The record management module 50 according to the present invention provides the function of storing and managing various records of the results of previous sports matches, and, in other words, functions to integrate and mange records of teams/team members and the scores and results of respective sports matches that have been previously carried out, into a database and to store and classify the records.

That is, the system of the present invention needs to manage teams, team members, sports match records, and results so as to provide a basis for recording the results of sports matches that have been conducted on the assumption that several teams are formed in the state in which a plurality of team members have already been assembled and that sports matches are conducted among the teams, and for holding other sports matches based on these records and organizing meets. Such a function is performed exactly by the record management module 50.

In detail, the record management module 50 includes an input unit 51 for receiving results and records of teams, team members, and individual matches, a storage unit 52 for storing the received records, and a classification unit 53 for classifying the stored records depending on individual detailed categories and classification criteria.

The input unit 51 functions to receive various records, that is, record data (record information), derived after sports matches have been conducted, from a sports match record manager (one of team members or one of separate record managers) via a mobile application or a web provided by the mobile communication terminal 30 or a web page, or via the member management platform 10.

The term ‘record data’ in the present invention denotes data not only including basic record information related to matches, such as the final victory/defeat results and scores, scores for each quarter, records of team members for respective positions (the number of goals made, the number of rebounds, the number of interceptions, etc.), and the records of the opponent teams, but also including external match records, such as information indicating whether an appointed play time has been abided by, the location and name of a stadium, and the playing time, in the case of, for example, basketball.

The storage unit 52 functions to store such record data that has been received via the input unit 51 in a record DB. The record DB can be stored in a separate DB server provided in the system according to the present invention.

The classification unit 53 functions to classify the stored record DB based on detailed-classification criteria.

For example, on the basis of a team member named “Kim”, the classification unit 53 may separately classify detailed data depending on the number of matches in which Kim has participated to date, results/records for respective matches, and results/records of a team to which the team member belongs. Further, on the basis of a team, the classification unit 53 may classify detailed data depending on the results of the team, the number of times the team won matches, the highest and lowest results of the team, average scores of individual matches, changes in team members, changed detailed-data, etc. Here, the classification criteria may be diversified depending on the characteristics of respective matches and teams, and a considerably various detailed data can be derived depending on classification schemes. The present invention is not limited to specific classification criteria and then record-related data is not basically restricted.

In other words, the classification unit 53 functions to not only set a basis for allowing teams having similar levels or results to match with each other when organizing a team and setting a rival, as will be described later, and organizing matches or meets, but also provide raw data that can be used when organizing the overall sports matches/meets.

Furthermore, the classification unit 53 includes a level classification means 54 for classifying the levels of teams/team members into levels (or can be represented by ranks, ranking or grades) such as A, B, and C based on the detailed record data that has been classified depending on respective classification criteria. Here, each level can be derived as various levels rather than only a single level depending on the classification criteria, and the levels classified depending on respective classification criteria by the level classification means can be separately stored in a level DB.

Such a level classification means is sufficiently described in a prior patent filed by the present applicant in relation to a method and technology for determining values or levels of team members, and thus a detailed description thereof is omitted.

In well-known technology for organizing and operating an online sports match, meets have been simply organized based only on physical record data such as areas or team results. However, in this case, existing teams that have been previously organized or existing team members and team members who newly subscribe to the organization were not acquainted with each other before. Therefore, since they have no sense of closeness, it was difficult to form a team or organize a meet, and in addition the rate of participation of persons was low in many cases.

Therefore, in a team member assembly and search function that is performed first so as to realize the formation of teams or the organization of meets pursued by the present invention, the present invention provides an interface for smoothly organizing a match and invigorating a sports match using a more abundant manpower pool not only by performing a search for organizing a team and a sports meet based on physical parameters such as time, place, and ability (levels designated by the classification), but also by introducing existing team members who have conducted activities to new members or by on the contrary inducing persons, who enjoy sports and have not subscribed as members, to subscribe as members or team members.

That is, the present invention performs the function of pursuing the activation of the organization of sports matches by providing a potential/realistic manpower pool that is capable of analyzing the sports inclinations of existing members/potential members, organizing teams/team members and forming sports matches, unlike the existing schemes. This function is performed on the premise that it can be provided in conjunction with a mobile communication terminal 30 (including a feature phone, a smart phone, iPod touch, etc.) held by each team member or that each module which will be described later can be provided in the form of a separate application (App) to the mobile communication terminal 30.

In other words, the present invention is intended to organize a sports match in the state in which the participation rate and awareness of members are sufficiently secured using both the team member management interface 100 for mainly detecting the sports inclination and sports matching conditions of existing members, revealing the detected information to the in online spaces, such as in a Social Networking Service (SNS), and discovering the sports preference and schedules of the existing team members, and an extension management interface 200 for securing potential manpower that indicates persons that are not yet members, thus invigorating sports matches.

The team member management interface 100 according to the present invention basically includes a condition registration module 110, and may additionally include a free schedule registration module 120 and a sports stadium visit registration module 130.

The condition registration module 110 functions to receive matching conditions from each team or each team member, store the matching conditions, and revealing them via the member management platform 10. Here, the matching conditions refer to basic participation or holding conditions of sports matches, such as match events desired by the team/team member, the scale of a meet, the range of the number of participating teams, the levels of participating teams, the incentive of the meet, and the levels of opponent team/team members, wherein the matching conditions are required by the team/team member and are entered together with the time and place of sports matches desired by the team/team member to participate in.

That is, basic matching criteria are set by the condition registration module 110, and an update function enabling the change or revision of matching conditions entered by the team member/team to be performed several times is provided without prohibiting change or revision after being entered at one time.

The free schedule registration module 120 registers and processes schedules related to the time and the place at which the team/team member freely enjoys sports games, rather than schedules related to sports matches managed by the present invention, that is, official schedules, depending on the entry of the team/team member.

Here, “the entry of a team” means that a representative of various team members constituting a team enters information, and can be used when desiring to set matching conditions on a team basis rather than on a team member basis.

That is, official schedules can be checked using notification such as a separate Short Message Service (SMS) or email, as in the case of a well-known method, after sports matches have been organized. The present invention provides the function of receiving the remaining schedules at which each team/team member can freely enjoy sports, to the exclusion of the official schedules (in the present invention, schedules at which the team member or the team freely enjoys sports, to the exclusion of the time required for reading or sleeping, are referred to as ‘free schedules’), storing the free schedules, and revealing them via the member management platform 10.

Such a free schedule may be installed on the mobile communication terminal 30 held by the team member as a basic function, or may be extracted from a schedule management program present in the form of an application.

The schedule management program is installed in the form of an application in smart phone applications, includes a well-known personal schedule management function, and is configured to record and store schedule keywords for each date/day of the week/time.

That is, keywords to which titles such as the names of sports match events/sports titles/exercise are assigned are selected from schedule items about the individual dates/times of the schedule management program using a keyword matching scheme, and schedules corresponding to the keywords, that is, data about the time and place, can be extracted.

Alternatively, the above-described free schedules can be received from a team member via a separate application or a web/mobile space provided by the present invention and can be stored.

Such a free schedule registration module 120 previously discovers a stadium frequently visited by each team member or a time span over which the team member visited the stadium so that a sports match can be smoothly conducted, and utilizes the stadium or time span as useful parameters when subsequently forming a sports match or organizing a team. In addition, such free schedules are revealed via an online space (mobile/web page or the like) provided by the system of the present invention, so that a member participation induction function which mediates meeting to members who do not yet frequently participate in sports matches or to new members and which induces the members to take interest in the sports matches can be provided.

The sports stadium visit registration module 130 functions to designate and register a stadium in each area or in a specific place, indicate the location of the stadium on a specific map based on Geographic Information System (GIS), and register the stadium in which a relevant team member equipped with the mobile communication terminal 30 is located or a time span over which the team member stays in the stadium by using the function of performing continuous location information communication with the mobile communication terminal 30 when the member is located in the stadium in the state in which the sports stadium visit registration module 130 is operated in conjunction with the GPS function of the mobile communication terminal 30 held by the team member or in the state in which the sports stadium visit registration module 130 is directly installed on the mobile communication terminal 30.

In the present invention, information including the stadium actually visited by the team member and the time span over which the team member stays in the stadium is referred to as ‘stadium visit data’.

That is, the present invention provides the function of determining based on GIS whether a specific team member has visited a designated stadium using a location notification function based on the GPS function held by the team member, and thereafter generating and registering stadium visit data.

In this case, the mobile communication terminal 30 held by the team member automatically transmits location information to the sports stadium visit registration module 130 when the team member enters the corresponding stadium in the state in which a list of designated stadiums is previously stored based on the GIS. Further, the mobile communication terminal 30 is provided with an application having the function of transmitting location information to the sports stadium visit registration module 130 at regular intervals while the team member stays in the stadium, stopping transmitting the location information when the team member leaves the stadium, and discovering the total time span during which the team member stayed in the stadium. That is, it is preferable for the sports stadium visit registration module 130 to discover stadium visit data of each individual team member, that is, the number of times the member visited the stadium, the location/name of the stadium, the time span, and date, in conjunction with the mobile communication terminal 30.

Such a stadium visit recording module 130 actually discovers unpredictable information indicating that a team member visited the stadium at an unscheduled time, as well as predictable information indicating that the team member actually visited the stadium according to the official schedule in which the sports match occurred, thus functioning to ensure the probability of meeting other team members by revealing the location and time at which the team member exercises or actually played a game via the online space provided by the system of the present invention.

In other words, the present invention discovers and reveals stadium visit data about stadiums in which a team member who desires to organize a sports match or participate in the sports match has visited, so that an opportunity for allowing another member/team member to actually meet the corresponding team member is provided by referring to the stadium visit data. Accordingly, the present invention provides a basis for allowing information and inclinations about sports matches, which are organized by the team together with the corresponding team member or are intended to be organized by the team to which the team member belongs, to be determined when another member/team member personally meets the corresponding team member.

The team member management interface 100 having the above configuration reveals information about existing team members who are enthusiastic about the participation in/organization of sports matches via the member management platform 10, thus providing the characteristic of inducing other team members or new members to attempt to participate in sports matches.

The extension management interface 200 according to the present invention is configured to provide a basis for assembling amateur athletes other than the members of the system according to the present invention or inducing existing members who are inactive to perform activities. As an example, the extension management interface 200 performs an induction function of capturing an athlete each member met in a frequently visited stadium or a specific area or an athlete having a specific sports inclination, and inducing the athlete to access the member management platform 10.

In detail, the extension management interface 200 includes an entity floating detection module 210, an entity tracking module 220, and a member activation module 230.

The term “entity” in the present invention refers to an amateur athlete who does not subscribe to the member management platform 10 provided by the system according to the present invention, that is, a potential member.

The entity floating detection module 210 is configured to detect the number of persons who visit a place which an athlete who is not yet a member frequently visits to enjoy sports, that is, a stadium, and then discover the quantity of floating persons in each stadium. The entity floating detection module 210 includes entrance/exit detection sensors 211, a floating entity calculation unit 212, and an opinion analysis unit 213.

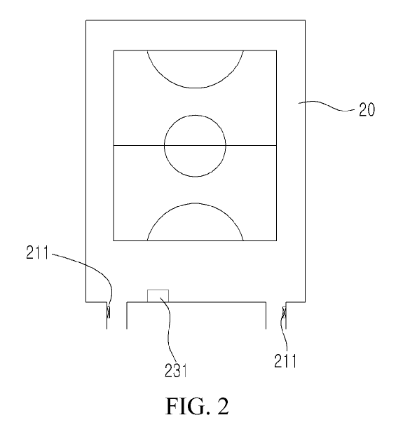

FIG. 2 is a conceptual diagram illustrating the configuration of entrance/exit detection sensors and an input device installed in a stadium.

The entrance/exit detection sensors 211 are installed at the entrance, the exit or transfer route of the stadium using a far-infrared transmission scheme, and are configured to function to detect persons who enter and leave the stadium.

In detail, it is preferable to install the entrance/exit detection sensors 211 at the entrance and the exit of the indoor stadium and to detect the situation of entrance/exit. Of course, the entrance/exit detection sensors 211 may be installed even in an outdoor stadium, so long as the line of flow or a route along which the status of the entrance/exit of persons can be detected is present.

The floating entity calculation unit 212 functions to receive detected information from the entrance/exit detection sensors 211 and detect the number of persons corresponding to floating entities in each stadium and in each specific time span.

The opinion analysis unit 213 uses opinion mining technology, and is configured to determine the atmosphere of a specific stadium and the number of persons in the stadium when an existing team member equipped with the mobile communication terminal 30 visits the specific stadium, and the approximate atmosphere of the corresponding stadium and the number of persons in the stadium, which are obtained by analyzing the meanings of words constituting a comment, in a time span over which the comment was input when comments for the number of persons for each event are input to the member management platform 10, that is, stadium inclination information, and to reveal the determined stadium inclination information via the member management platform 10.

Here, the opinion mining program can be used when analyzing the meanings of the words. The opinion mining program has a semantic library capable of determining not only the form of sentence structures such as the positions of words, modifying/modified relationships among the words, and the arrangement of the words, but also the meanings of the words, that is, the likes/dislikes, affirmation/denial, and quantity of words, thus enabling stadium inclination information in which the atmosphere of the stadium meant by the comment is recorded to be generated via the semantic library.

That is, the entity floating detection module 210 can provide a basis for determining the number of persons who are playing sports in a specific stadium based on a social network or based on sensors installed in the stadium, and allowing an existing team member to select a time span over which there are a larger number of floating persons, visit the corresponding stadium, and induce floating entities to subscribe as members.

The entity tracking module 220 determines the number of times a specific member who subscribed to the member management platform has participated in sports matches (a participation rate) based on the record data of the record management module. Then, the entity tracking module 220 functions to extract each member whose participation rate was determined to be less than a reference preset by the system according to the present invention (for example, when the number of times a relevant member who has interest in basketball has participated in sports matches for one year is two, and the number of times that sports meets have been held for one year is 25 only in New York, the participation rate can be determined to be 8%, and the reference is set such that when the participation rate is less than 30%, the participation rate is determined to be low), and then generate target-of-interest member information from the extracted member information.

Such an entity tracking module 220 first determines members who are inactive and then provides a basis for allowing a participation induction module 340, which will be described later, to perform separate management.

The member activation module 230 is configured to provide a basis for allowing athletes participating in a sports match to subscribe as a member via a device separately installed in the stadium or prompting members who have a low participation rate to actively take part in activities via a separately provided input means on the member management platform 10. The member activation module 230 includes an input device 231 and an advertisement display unit 232.

The input device 231 may be directly implemented using a separate hardware device installed in the stadium or using the mobile communication terminal 30 held by each existing member. On the member management platform 10, it is possible to prepare and provide a separate input box.

That is, the input device 231 directly installed in the stadium includes an event provision message and advertisement content for introducing various incentives and benefits that may follow upon participating in a sports match. The advertisement display unit 232 functions to display such advertisement content.

Furthermore, the advertisement display unit 232 is provided with a proximity sensor and is then capable of including the function of displaying advertisement content only when a specific athlete approaches the nearby region of the advertisement display unit.

Thanks to the function of the advertisement display unit 232, it is possible to attract the interest of members who are inactive, or non-members, thus allowing the non-members to naturally subscribe as members via the input device 231. In a stadium in which there is no input device 231 and no advertisement display unit 232, the present invention provides the function of allowing persons to subscribe as members via the input device 231 provided on the mobile communication terminal 30 held by an existing member while the existing member personally visits the stadium and advertises sports matches.

Such an extension management interface 200 is provided with the function of extracting existing members who are inactive while discovering a place where athletes who are not yet members are assembled and having the effect of inducing member subscription, thus making it convenient to perform the function of inducing manpower to be secured so that sports matches run more smoothly.

The organization management interface 300 according to the present invention provides the function of organizing an actual team and a sports meet based on the team member management interface 100 or the extension management interface 200. The organization management interface 300 may basically include a matching condition search module 310 and a match organization module 320, and may further include a team member pattern extraction module 330, a participation induction module 340, and a rival management module 350.

First, the matching condition search module 310 provides the function of searching for members (teams/team members) that satisfy individual matching conditions registered and stored in the condition registration module 110 provided in the team member management interface 100, and also allowing other members to view the free schedule registration module or the stadium visit module via the member management platform and collecting requests for participation.

Here, when a search is performed, search similarity can be set. That is, search similarity can be represented by percentages such as 100% or 80%, a similarity of 100% is used to search for other team members satisfying 100% of matching conditions entered by the team member, and a similarity of 80% means that other team members satisfying 80% of the matching conditions entered by the team member can be searched for.

Criteria for deriving values of search similarities such as 60% or 80% are configured to determine whether detailed conditions constituting the matching conditions are satisfied, based on a percentage.

Furthermore, an extensible search function can be included to automatically perform a multi-stage search while gradually decreasing similarity in such a way as to perform a 100% similarity search in a primary search stage and an 80% similarity search in a secondary search stage.

In this case, advertisement content provided by the advertisement display unit 232 when inducing non-members to subscribe as members may include incentive information provided when participating in a sports meet.

Furthermore, the present invention includes the function of assigning priorities to detailed matching conditions and performing the search depending on the priorities. For example, it is possible to adjust the priorities of respective detailed matching conditions in such a way as to set an area as a first priority condition and set ability as a second priority condition, and then perform the search.

Further, the free schedule registration module 120 or the stadium registration module 130 may provide a separate search procedure using a configuration which will be described later. However, the matching condition search module may provide the function of receiving and collecting a participation request made when another team member desires to be directly matched with a specific team member with reference to the free schedule information or stadium visit data of the specific team member. In this case, the team member who entered matching conditions can determine whether to accept the request in conjunction with the acceptance unit 322 of the match organization module 320, which will be described later.

The match organization module 320 is configured to organize an actual sports match in conjunction with the results of the search derived by the matching condition search module 310 or in conjunction with the results of the operations performed by the team member pattern extraction module 330 and the participation induction module 340 which will be described later. The match organization module 320 includes in detail a requesting unit 321, an acceptance unit 322, and an organization unit 323.

The requesting unit 321 provides the function of requesting team members/teams appearing in the results of the search to consider whether to participate in a sports meet, and may include the function of showing the results of the matching search to the team member who entered the matching conditions, and sending an acceptance request message to a specific team member/team manually selected by the team member from among the team members/teams appearing in the results of the search via the member management platform 10, or automatically sending an acceptance request message at a time to all the team members/teams derived as the results of the search.

The acceptance unit 322 provides the acceptance function of allowing the team members/teams who received the acceptance request message from the requesting unit 321 to accept the request to participate in a sports match by pressing an acceptance button.

The organization unit 323 functions to extract a team member/team that accepted to participate in the sports match via the acceptance unit 322 and the team member/team that entered the matching conditions, generate a list of matches based on the detailed levels or the like classified by the classification unit 53 of the record management module 50, collect information such as match schedules and detailed items required to operate the match, and organize the match.

In particular, the organization unit 323 provides criteria for making an incentive payment based on the results of the sports match. Incentive can be paid in such a way that as the number of teams participating in the match increases, the incentive increases as in the case of a social commerce method a group purchase form. Further, conditions such as a differentiated incentive payment scheme can be assigned such that different incentives are paid according to the scales of matches or variables in victory or defeat over the matches, and such that more incentives can be paid in the case where the team that organized the match won the match than in the case where other teams won the match. Furthermore, conditions such as a match scale-based differentiated incentive payment scheme can be assigned such that more incentives are paid in the major league than in the minor league. Furthermore, conditions such as a rival match-based differentiated incentive payment scheme can be assigned such that different incentives are paid when a match between rivals is conducted, which will be described later.

Such an incentive system can be applied and changed in various manners in conformity with specific rules and detailed criteria.

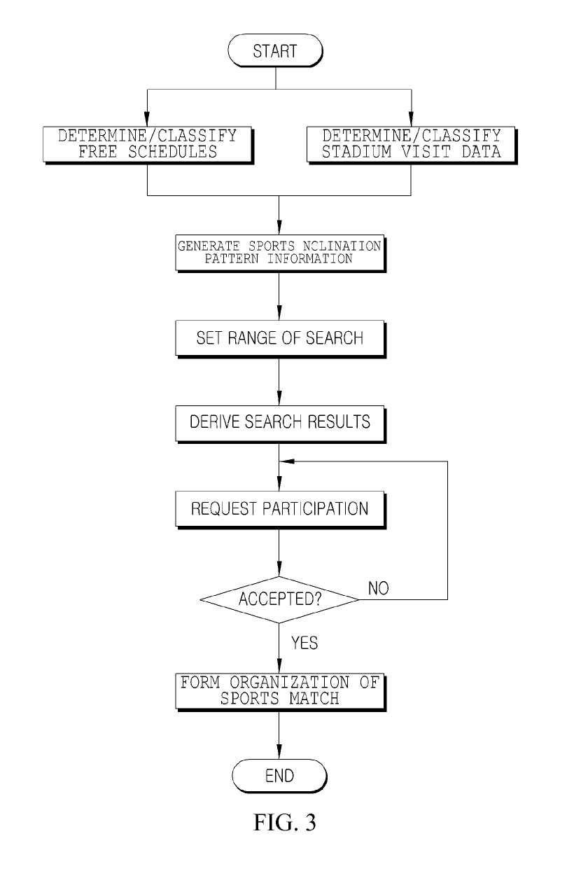

FIG. 3 is a flowchart schematically showing the procedure of determining the sports inclinations of team members and forming the organization of a sports match.

A team member pattern extraction module 330 is configured to discover the sports inclination patterns of team members via the free schedule registration module 120 and the sports stadium visit registration module 130 that are additionally provided by the team member management interface 10, and includes a pattern discovery unit 331, a search range setting unit 332, a search unit 333, and an organization management unit 334.

The pattern discovery unit 331 functions to integrate free schedules of each team member registered in the free schedule registration module 120 of the team member management interface 100 and stadium visit data registered in the sports stadium visit registration module 130 at regular periods, and generate so-called “sports inclination pattern information” in which various types of information, such as the sports play time, the sports event (when the team member inputs a sports event to the free schedules), the actual sports play time and place, and the frequency of participation in actual sports compared to the free schedules, are recorded.

That is, the sports inclination pattern information provides a basis for discovering a temporal range and a spatial range in which each specific team member can play sports in more detail and more realistically. For example, sports inclination pattern information can be represented by, for example, ‘A team member named Hong Gil Dong is a guard belonging to A team mainly playing basketball games, and desires to play sports three times a week on the average, but actually played sports about twice, and then the free schedule vs. sports play percentage (referred to as an ‘sports play value’ in the present invention) of the team member is 67%, and the time span over which the team member plays sports is on Thursday evening according to the result of analyzing the average time for four weeks'. In particular, the average number of times of playing sports, the time span, the actual time span of playing sports, and the place of playing sports can be represented by and stored as values or codes (mainly for the place of playing sports).

The search range setting unit 332 can set the range of search based on percentages, that is, a sports play value (the value indicated by 67% in the above example) in sports inclination pattern information derived by comparing stadium visit data, in which actual sports play times are recorded, with sports play times which were set in the free schedules, in the order of higher or lower sports play values of team members when searching for team members who are able to participate in a sports meet based on the sports inclination pattern information.

That is, a team member having a higher sports play value is determined to have a tendency to strictly abide by his or her promises. Accordingly, the team member is set in the range of a search requiring higher sports play values in the organization of a sports meet that is determined to require that a promise be strictly abided by, otherwise he or she is set in the range of a search having relatively low sports play values.

In other words, the search range setting unit 332 provides online inclination analysis technology-based characteristics that enable team members to be searched for in consideration of even the faithfulness of the team members indicating whether they always abide by promises, as well as the time spans in which the team members mainly plays sports.

The search unit 333 provides the function of searching for teams/team members who will participate in a sports match depending on the matching conditions based on the search range set by the search range setting unit 332. The organization management unit 334 provides participation request and acceptance functions and an organization function to the teams/team members appearing in the results of the search by the search unit 333 in conjunction with the match organization module 320, or the function of organizing a sports meet in combination with the functions of the match organization module.

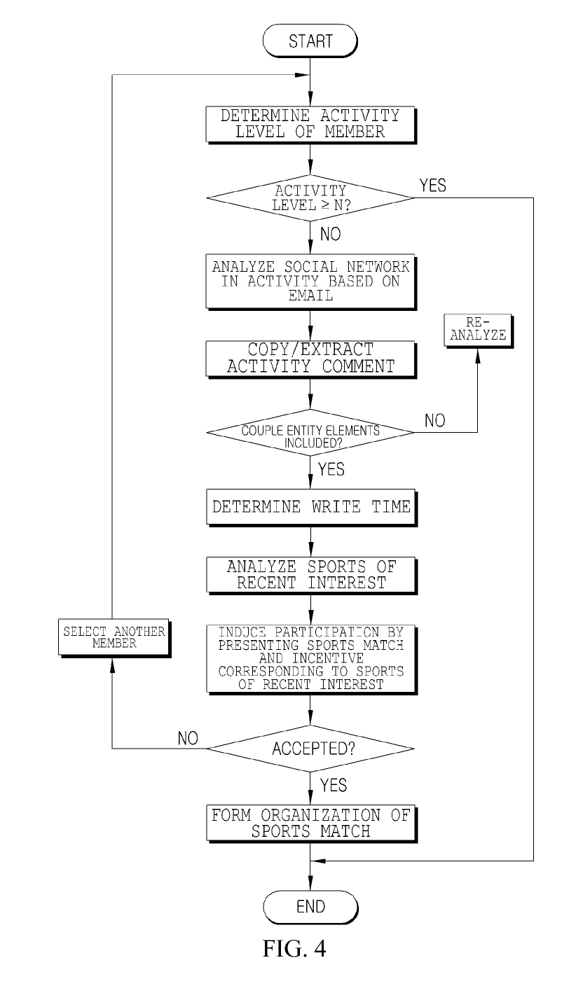

FIG. 4 is a flowchart schematically showing the procedure of analyzing sports that members who are inactive are recently interested in and inducing the members to participate in a sports match.

The participation induction module 340 provides the function of determining the sports of recent interest of members (target members of interest) having a low rate of participation in sports meets, which have been discovered by the entity tracking module 220 of the extension management interface 200, and directly requesting the members to participate in a sports meet when a sports meet suitable for the inclinations of the members is held. The member activation module 230 merely displays advertisement content to non-members. However, the participation induction module 340 provides the function of extracting inclination information (the sports of recent interest) by means of comments written by members via the member management platform 10 or comments written by the members on other social network websites, and sending a message for recommending a sports match satisfying the requirements of the inclination information or for inducing the corresponding members to participate in the sports match, based on the extracted inclination information, either once or periodically.

That is, for those members who had subscribed to the system of the present invention and who are inactive in their participation and activities, the participation induction module 340 considers that there will be few comments written by the corresponding members via the member management platform 10, and provides an scheme for tracking an online community space or a social network space in which the members are active, determining whether activities related to sports are present in the social network activities of the members, and recommending a sports match suitable for the corresponding sports or inducing the members to participate in the sports match.

In detail, the participation induction module 340 includes a social web activity analysis unit 341, a couple entity element analysis unit 342, a write time determination unit 343, a sports-of-interest analysis unit 344, and a participation induction unit 345.

The social web activity analysis unit 341 functions to determine the activity state of each member on other social webs using an external interworking function or other well-known interworking schemes based on an email address among pieces of member information recorded on the member management platform 10 when the member subscribed as a member.

Social webs are based on current well-known websites such as Facebook, Twitter, and Me2 day (an SNS operated by Korean Naver) or social webs that can associate information with the member management platform 10 according to the present invention. Whether the corresponding member shows any activity on a specific social web can be determined by accessing the corresponding social web, entering the email address of the member into a search box, and executing a ‘find friends’ function.

In the state in which it is determined that a social web in which activity has been shown is present, the social web activity analysis unit 341 accesses the homepage of the corresponding member on the social web, copies the comments written by the member per sentence, and also records times at which the corresponding comments were written.

The couple entity element analysis unit 342 functions to determine whether a keyword including a sports-related entity element and a keyword including an entity element having a verb indicative of an action in words prior to and after the sports-related entity element, are included in each sentence of the copied comments of the member, and generate member inclination information.

The couple entity elements in the present invention denote keywords forming a pair, that is, first and second entity elements. The first entity element denotes a sports-related keyword, and the second entity element denotes a verb keyword indicative of an action in a sentence including the first entity element.

That is, when the first and second entity elements are included in a single sentence, it is concluded that an action related to sports is present, and each sentence is identified using the beginning of a new line or a period (.).

For example, when there is the sentence “I would rather pay basketball.”, the first entity element is ‘basketball’, and the second entity element is ‘would rather play’. By this analysis, the type of sports and whether the action of the sports has been conducted can be roughly determined.

Of course, unless the entire sentence is analyzed, there may occur the case where noise occurs and then there is an error in a sports action determination procedure, which will be described later, when using only the couple entity element determination method based on two entity elements. However, upon conforming to a scheme for analyzing the entire sentence, a lot of time and effort may be required. In addition, the object of the present invention is to merely determine whether a sports action has been conducted and to induce the member to play sports, rather than individually analyzing detailed situations of each member, so that the purpose of analysis in the present invention can be sufficiently achieved.

The write time determination unit 343 determines a write time at which the corresponding sentence was written in the state in which the sentence including couple entity elements has been extracted, and determines whether the sentence was written prior to a predetermined time (three months or six months ago). That is, the write time determination unit 343 provides the function of determining a time point at which the sports action of interest determined by the couple entity element analysis unit 342 was conducted. The present invention is intended to select a sports action of recent interest.

The sports-of-interest analysis unit 344 performs the function of considering that when couple entity elements are included in the comment of the member which has been entered within a predetermined period, the member recently has an interest in the sports included in the first entity element.

That is, the sport-of-interest analysis unit 344 captures the sports in which the member recently has an interest.

Of course, it is easy to determine the favorite sports of the member by making queries about favorite sports and the sports of interest when a person subscribes to the system of the present invention as a member. However, in general, since sports enjoyed at the amateur level can be easily changed, the above-described configuration is required to determine the sports in which the member has interested the most recently.

When the sports of recent interest of the member who is inactive are captured, the participation induction unit 355 functions to introduce a sports match being organized for the sports, incentives applied to the sports match, and a team member who enjoys the corresponding sports, on the social web on which the member shows any activity or by email either once or periodically, thus attracting the member's attention and inducing the member to participate in the sports match.

The above configuration provides the characteristics of determining the recent favorite sports of the member who is inactive on the assumption that the member is interested in sports, but may not exhibit his or her interest for several reasons, and introducing a sports match (target match) being organized for the sports, team members (persons), and incentives (benefits) to the member, thus attracting the member's attention.

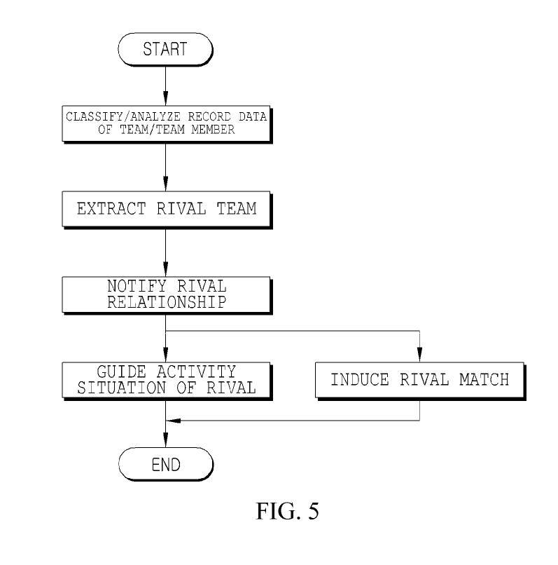

FIG. 5 is a flowchart schematically showing the procedure of managing a rival team.

The rival management module 350 sets a rival having an ability or situation similar to that of each team, and provides a basis for playing a friendly match with the rival and holding a new sports meet together with the rival. The rival management module 350 includes in detail a rival extraction unit 351, a rival activity situation guidance unit 352, and a rival match induction unit 353.

The rival extraction unit 351 functions to extract each team, the victory or defeat of a match of which was determined by a narrow margin as a result of a match with a specific team, each team, the entire ratio of victories and defeats of which is similar to that of the specific team, or each team having results similar to those of the specific team in a plurality of sports matches, from record data stored in and classified by the record management module 50.

That is, at least one team having results similar to those of the specific team is extracted and stored based on the record data, and this team is called a rival. The rival extraction unit 351 includes the function of notifying a team selected as the rival of a rival relationship once the rival has been extracted.

In this case, when the extraction of rival teams reveals that there are few rival teams or there is no rival team, teams belonging to other areas can even be extracted as rival teams.

The activities of teams extracted as rivals are reported to opponent rival teams either in real time or at regular periods via the rival activity situation guidance unit 352. The rival activity situation guidance unit 352 includes the function of collecting the match records of each rival team using the record management module 50, reporting the collected data to the opponent rival team, also collecting even stadium visit data about each team member of the rival team in conjunction with the sports stadium visit registration module 130, and notifying the opponent rival team of this situation in real time when the rival team/team member visits a specific stadium. Therefore, the current situation is reported to the opponent rival team (at least one of the team members constituting the opponent rival team) via the member management platform.

The rival match guidance unit 353 takes charge of assigning priorities to rival teams and presenting the rival teams as higher-rank search results when it is desired to organize a sports meet in conjunction with the matching condition search module 310. That is, the rival teams are provided as the results of the search separately from the results of the search by the matching condition search module 310, and an opportunity to allow both teams to frequently play sports matches can be provided.

Tension can be formed and competitive spirit can be heightened between the teams playing a sports match by the rival management module 350. The rival management module 350 then provides a scheme that provides the characteristics of assigning an opportunity to frequently hold sports matches and ultimately invigorating sports matches.

After sports matches have been organized by the above configuration, the system of the present invention can provide the function of operating sports matches using well-known schemes, determining victory or defeat and rank, awarding a winning team or a team having excellent results, and resetting levels depending on the results of sports matches.

In accordance with the system for invigorating an online sports match according to the present invention, the following advantages can be obtained.

1) There is an advantage in that member management and manpower security which may be regarded as a primary basis for invigorating a sports match can be reasonably and scientifically performed.

2) An opportunity to discover floating persons in respective time spans of a designated stadium so as to assemble amateur athletes who are not yet members and to do promoting can be assigned.

3) When an existing member personally visits a stadium and writes a comment about the atmosphere of the stadium, the atmosphere of the stadium is analyzed based on an opinion mining program, thus enabling a target stadium for promotion to be set.

4) In addition, the present invention determines sports in which members who are inactive recently have an interest via the universal online activity inclinations of the members, and performs promotion and advertising based on the sports, thus providing the effect of activating the participation of members.

As described above, although the configuration and operation of a system for invigorating an online sports match according to the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for invigorating an online sports match, comprising:
a member subscription module for processing subscription of members while receiving member information;
a member management platform for providing information about a sports meet to the members based on a social web;
a record management module for storing and classifying information about results of sports matches of a team to which the members belong as team members and each of the team members;
a team member management interface including a condition registration module for receiving and storing matching conditions required to organize a sports match on a team basis or on a team member basis, and revealing the matching conditions via the member management platform, a free schedule registration module for generating free schedule information by extracting sports schedules and sports play time and place thereof, recorded in a schedule management program of a mobile communication terminal held by each team member, and revealing the free schedule information via the member management platform, and a sports stadium visit registration module for generating stadium visit data, in which location of a stadium visited by a specific member and a time span over which the specific member visited the stadium are recorded, based on a situation in which the specific member equipped with a mobile communication terminal having a positioning function of Global Positioning System (GPS) visited a designated stadium based on Geographic Information System (GIS), and revealing the stadium visit data via the member management platform; and
an organization management interface including a matching condition search module for providing a function of searching for at least one team and at least one team member that will participate in a sports match based on the matching conditions and the free schedule, and searching for at least one team and at least one team member that will participate in a sports match in a state in which the stadium visit data is additionally included, a match organization module for sending a participation request to the team and the team member found by the matching condition search module and forming organization of the sports match when the team and the team member accept the request, and a rival management module including a rival extraction unit for extracting a rival team for a specific team based on results in record data stored in and classified by the record management module and notifying the specific team of the rival team, and a rival activity situation guidance unit for providing record data about the rival team and free schedule information and stadium visit data about each team member constituting the rival team on a homepage on a member management platform of any one of the specific team and at least one team member constituting the specific team at regular periods.

2. The system according to claim 1, wherein the organization management interface further comprises a team member pattern extraction module including a pattern discovery unit for integrating the free schedule and the stadium visit data at regular periods and generating sports inclination pattern information that includes sports play time and place for each specific team member, a search unit for searching for at least one team and at least one team member that will participate in a sports match based on the sports inclination pattern information and the matching conditions, and an organization management unit for sending a participation request to the team and the team member extracted as search targets, and forming organization of the sports match when the team and the team member accept the request.

3. The system according to claim 2, wherein the team member pattern extraction module further comprises a search range setting unit for adjusting high/low levels of a sports play value of the sports inclination pattern information and setting a range of a matching search.

4. The system according to claim 1, further comprising an extension management interface comprising,
an entity floating detection module for detecting a number of persons who visit each stadium in each time span using entrance/exit detection sensors installed at an entrance of the stadium; and
a member activation module for allowing persons who visit the stadium to subscribe as members via an input device installed in the stadium or an input device included in a mobile communication terminal held by each team member who visits the stadium, in a state in which an advertisement display unit is included in the member activation module, wherein the advertisement display unit is installed in the stadium or provided in the mobile communication terminal of the team member and is configured to display advertisement content introducing a sports meet and indicating incentive information.

5. The system according to claim 4, wherein the extension management interface further comprises an entity tracking module for detecting a rate of participation of each member in a sports match based on the record data, extracting a member whose participation rate is less than a preset reference, and generating target member-of-interest information.

6. The system according to claim 5, wherein the organization management interface comprises a participation induction module comprising,
a social web activity analysis unit for determining whether a member included in the target member-of-interest information shows activity on an external social web based on an email address recorded by the member on the member subscription module, and extracting comments written by the member when showing activity;
a couple entity element analysis unit for dividing the extracted comments into sentences, and determining whether both a first entity element implemented as a sports-related keyword and a second entity element implemented as a verb keyword indicative of an action at positions prior to and after the first entity element are included in each sentence;
a write time determination unit for determining a time at which the sentence including the first and second entity elements was written in a state in which the sentence is extracted;
a sports-of-interest analysis unit for determining whether the time determined by the write time determination unit belongs to a preset period, and then discovering sports in which the member recently has an interest; and
a participation induction unit for selecting another member who designated the sports of recent interest discovered by the sports-of-interest analysis unit as sports of interest, and introducing a type of sports match for the sports and results of the sports match to the selected member by email.

7. The system according to claim 1, wherein the rival management module further comprises a rival match induction unit for operating in conjunction with the matching condition search module, designating a rival team as a higher-rank matching condition compared to the matching conditions, and providing the rival team as results of a search based on the matching conditions.
